(19) United States
(12) Patent Application Publication
(10) Pub. No.: US 2006/0056139 A1
(43) Pub. Date: Mar. 16, 2006

(54) Ceramic computer apparatus

(76) Inventor: Yi-An Liu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/937,277

(22) Filed: Sep. 10, 2004

(51) Int. Cl. G06F 1/16

(52) U.S. Cl. 361/683

(57) ABSTRACT

A ceramic computer apparatus has a base module, a ceramic body, a supported module, and a computer product. The ceramic body connected to the base module has an open portion on the side wall. The supported module is mounted to the base module. The computer product is installed in the supported module and aligned with the open portion. Therefore, the present invention can combine a ceramic device and computer products. It has both the functions of computer products and the excellent appearance of the ceramics, and will improve the appearance of computer products extensively.

### BACKGROUND OF THE INVENTION

1. Field of the Invention

The present invention relates to a ceramic computer apparatus which combines ceramics and computer products by installing computer products in ceramic cases.

2. Description of the Related Art

The computer is one of the greatest inventions in human history, and it plays an important role in our lives. Regardless of whether we are at work or enjoying ourselves, we are increasingly reliant on it. With the development of the computer industry, a variety of computer products have been invented. However, most kinds of cases for computer products are made of metal or plastic. There is still plenty of room for improvement in the aesthetics of the computer industry.

As the technology of ceramic production matures, people are seeing more and more ceramic products in their daily lives. Ceramic products are both attractive and functional. Although there are people who are skilled in ceramics and computers, there still isn't a technology which combines these two products together to improve the computer's appearance.

For the reasons described above, the inventor has created an apparatus which provides a rational and effective structure to improve a computer's appearance by combining computer products with ceramics.

### SUMMARY OF THE INVENTION

The main purpose of the present invention is to provide a ceramic computer apparatus that combines ceramics and computer products. Therefore, this ceramic computer apparatus has both the functions of computer products and the excellent appearance of ceramics. It will improve the texture and the appearance of computer products extensively.

In order to achieve the objectives described above, the present invention provides a ceramic computer apparatus comprising a base module, a ceramic body which is arranged on the base module and has an open portion in the side wall, a supported module which is mounted to the base module, and at least one computer product which is installed in the supported module and aligns with the open portion of the ceramic body.

For further understanding of the invention, please refer to the following detailed description illustrating the embodiments and examples of the invention. The description is only for illustrating the invention and is not intended to be considered limiting the scope of the claim

### BRIEF DESCRIPTION OF THE DRAWINGS

The drawings included herein provide a further understanding of the invention. A brief introduction of the drawings is as follows:

FIG. 1 is an exploded perspective view of the ceramic computer apparatus;

FIG. 2 is an exploded perspective view with more details of the ceramic computer apparatus;

FIG. 3 is a perspective view of the ceramic computer apparatus; and

FIG. 4 is a cross-sectional view of the ceramic computer apparatus.

### DETAILED DESCRIPTION OF THE PREFERRED EMBODIMENTS

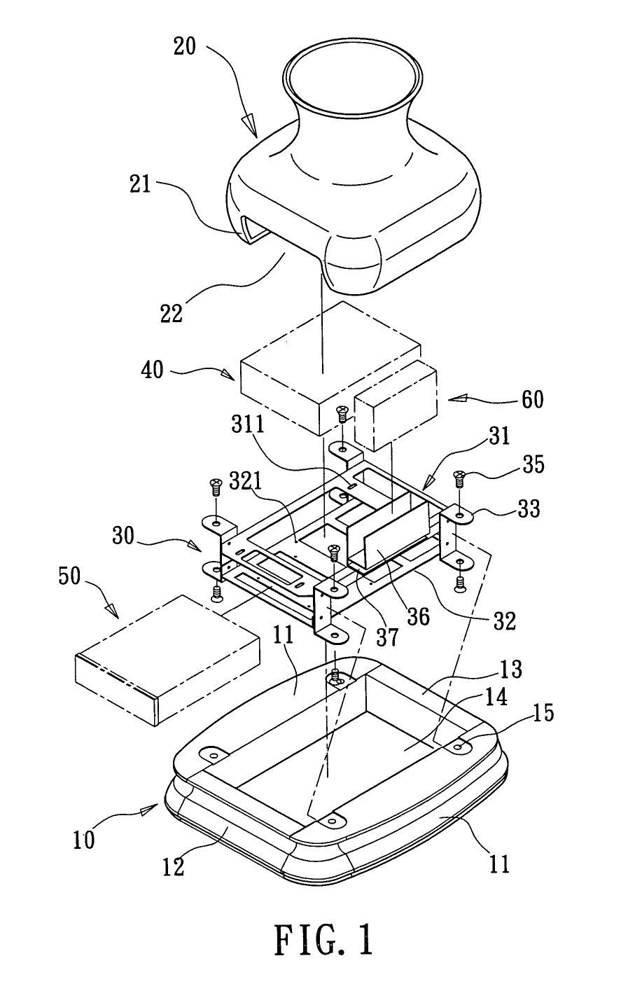

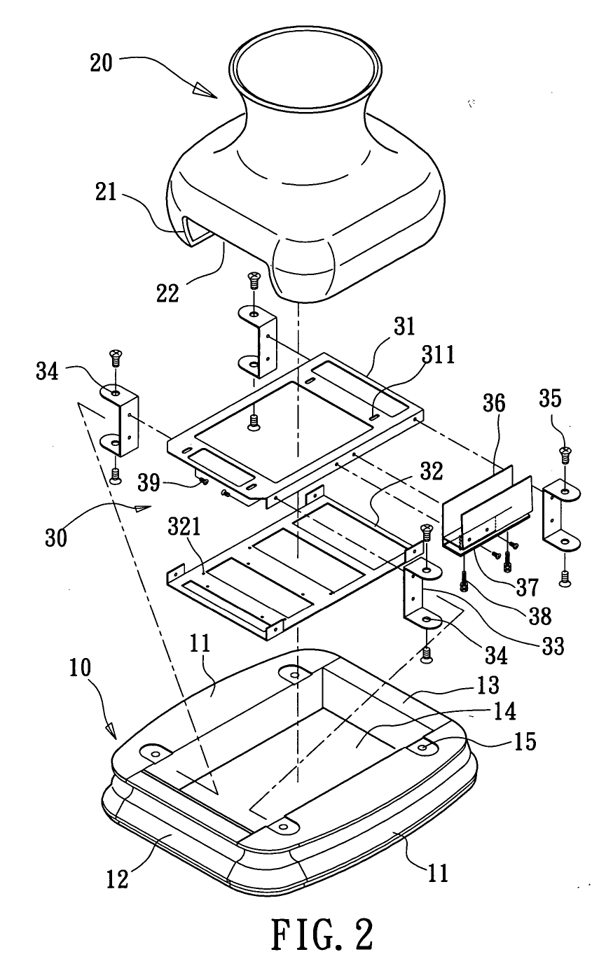

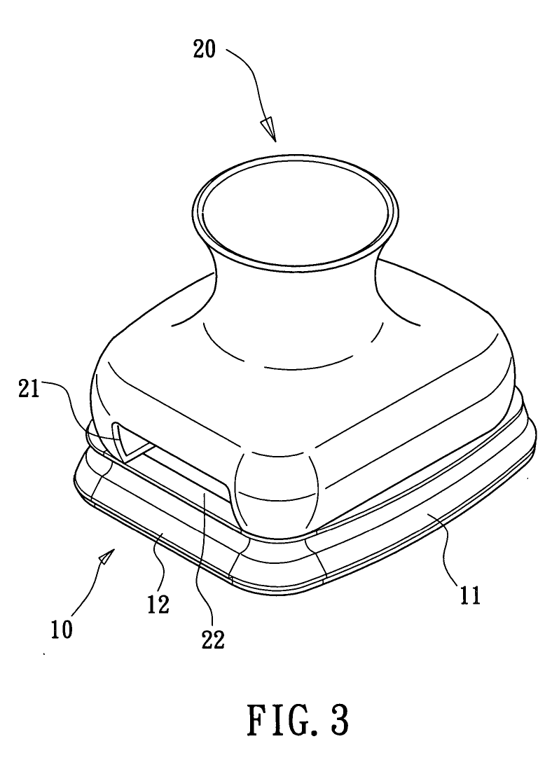

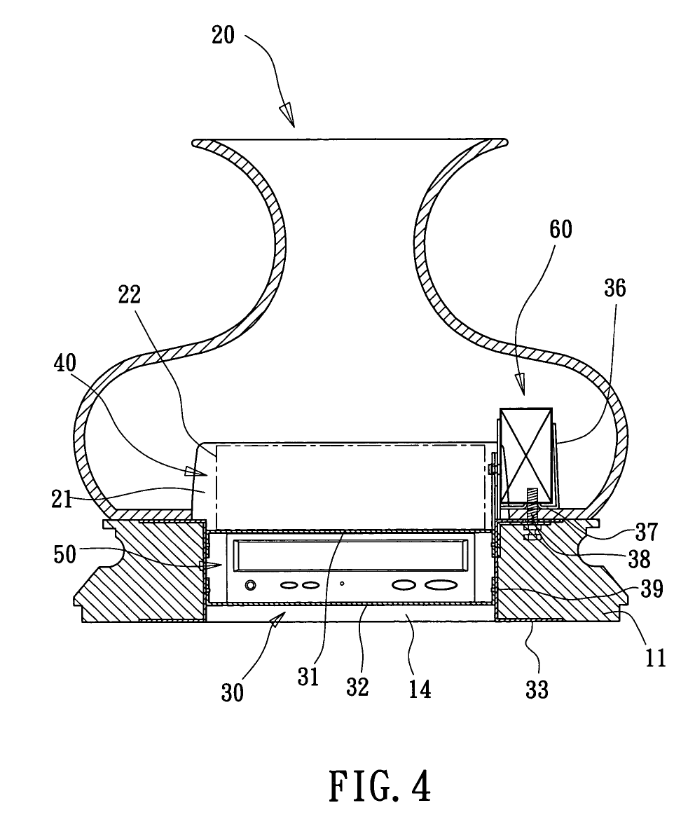

Referring to FIGS. 1, 2, 3, and 4, the present invention provides a ceramic computer apparatus comprising a base module 10, a ceramic body 20, a supported module 30, a first computer product 40, and a second computer product 50. The base module 10 is made of wood, comprising two side frames 11, a front frame 12 and a back frame 13. The two side frames 11 are positioned opposite to each side of the base module 10. The front frame 12 and the back frame 13 are separately connected to the front end and the back end of the two side frames 11 to compose the base module 10 with an indention chamber 14. The base module 10 connects to the supported frame 30 and the second computer product 50. The front frame 12 and the back frame 13 are separately connected to the two side frames 11, so that it is easy to assemble and disassemble the second computer product 50. The shape of the base module 10 is unlimited and changeable to fit the the ceramic body 20. In order to mount with the supported module 30, each of the two side frames 11 of the base module 10 has two first located holes 15 on the top and the bottom.

The ceramic body 20 is a ceramic device in the shape of a Chinese bottle located upon the base module 10. The ceramic body 20 has two open portions 21 on the front side and back side walls near the bottom. The ceramic body 20 has an inner hollow space 22 linking up with the open portion 21.

The supported module 30 is made of aluminium. The supported module 30 comprises an upper layer supported frame 31 and a lower layer supported frame 32. The upper layer supported frame 31 and the lower layer supported frame 32 are plate frames with a hollow shape and have many locked holes 311 and 321, which locks the computer product 40 and 50 in to place with bolts. The upper layer supported frame 31 and the lower layer supported frame 32 are opposite to each other in upper and lower positions and each has two corner locked frames 33 on the left and right side, wherein the corner locked frame 33 is bolted to the the upper layer supported frame 31 and the lower layer supported frame 32 by locked elements 39. The corner locked frame 33 has a second locked hole 34 on the top and bottom ends. The supported module 30 is cross mounted to the two side frames 11 of the base module 10 by four corner locked frames 33, and is bolted with second locked holes 34 and first locked holes 15 by locked elements 35. The supported module 30 is mounted to an indention chamber 14 of the base module 10. One side of the supported module 30 is connected by bolts with a power supply frame 36 that supports a power supply 60. A fixture bracket 37 on the bottom of the power supply frame 36 bolted to to the bottom of the base frame 20 by locked screws 38. In this way, the ceramic body 20 is arranged upon the supported module 30.

The first computer product 40 is located on the top of the supported module 30 and is mounted to the supported module 30 by screwing it through locked holes 311. The first computer product 40 is installed in the hollow space 22 of the ceramic body 20 and the front and back side of the first computer product 40 is aligned with the open portion 21 of the ceramic body 20.

The second computer product 50 is included inside the support module 30 and attached to the indention chamber 14 of the base module 10 by screwing the locked holes 321 of the supported module 30.

This invention isn't limited by any kind of computer product. Main machines, recorders, card reading machines and storage devices are all compatible with this product.

The present invention provides a ceramic computer apparatus to combine ceramics and computer products. Therefore, this ceramic computer apparatus has both the functionality of computer products and the excellent appearance of ceramics. It will improve the appearance of the computer products extensively.

The description above is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A ceramic computer apparatus comprising:
a base module;
a ceramic body having an open portion on a side wall thereof, the ceramic body is arranged on the base module;
a supported module mounted on the base module; and
a computer product arranged on the supported module, and the computer product is aligned with the open portion.

2. The ceramic computer apparatus of claim 1, wherein the base module comprises two side frames, a front frame and a back frame to define an indention chamber in an inside thereof for connecting to the supported module and a computer product.

3. The ceramic computer apparatus of claim 2, wherein the front frame and the back frame are separately connected to the two side frames of the base module.

4. The ceramic computer apparatus of claim 2, wherein the two side frames of the base module each have first locked holes on a top and a bottom thereof, the supported module comprises an upper layer supported frame and a lower layer supported frame, the upper layer supported frame and the lower layer supported frame each have two comer locked frames that are bolted to the two sides thereof, the comer locked frame has two second locked holes on both a top and a bottom end, the supported module is cross connected on the two side frames of the base module and is bolted to the second locked holes and the first locked holes by locked elements, the supported module is mounted to the base module and aligned with the indention chamber, the computer product is installed on an inside of the supported module.

5. The ceramic computer apparatus of claim 1, wherein the ceramic body has an open portion on a bottom thereof adjacent to a front and a back side wall and has a hollow space in communication with the open portion, the computer product is installed in the hollow space.

6. The ceramic computer apparatus of claim 1, wherein the ceramic body is arranged to the support frame.

7. The ceramic computer apparatus of claim 1, further comprising a power supply frame connected to a side of the supported module, and a power supply is disposed to the power supply frame.

8. The ceramic computer apparatus of claim 1, wherein the supported module has a plurality of locked holes to lock the computer product by locked elements.
